(19) United States
(12) Patent Application Publication
(10) Pub. No.: US 2013/0119269 A1
(43) Pub. Date: May 16, 2013

(54) APPARATUS FOR CURING THE COATING OF A COMPONENT BY MEANS OF FREE RADICALS GENERATED BY ULTRAVIOLET (UV) RADIATION

(71) Applicant: Jon Olloquiegi Arrayago, Lezo (Gipuzkoa) (ES)

(72) Inventor: Jon Olloquiegi Arrayago, Lezo (Gipuzkoa) (ES)

(73) Assignee: Lifitec ,S.L.U., Lezo (Gipuzkoa) (ES)

(21) Appl. No.: 13/812,765

(22) PCT Filed: Jul. 28, 2011
(86) PCT No.: PCT/ES2011/000243

§ 371 Date: Jan. 28, 2013

(30) Foreign Application Priority Data
Jul. 29, 2010 (ES) P201000989

(51) Int. Cl. B05C 9/12

(52) U.S. Cl. CPC B05C 9/12
USPC 250/454.11

(57) ABSTRACT

Apparatus for curing the coating of a workpiece (2), which comprises a tank (1) that contains an inert gas heavier than air and into which the workpiece (2) is inserted, and at least one UV-radiation source (4) situated on the exterior (E) of the tank (1) and facing at least one window (3) of the tank (1) to allow the UV radiation to pass through the window (3) towards the interior (I) of the tank (1). To prevent the interior of the tank (1) from overheating and to keep the inert gas atmosphere stable, the apparatus comprises at least one transparent filter (5) disposed between the UV-radiation source (4) and the window (3), where said transparent filter (5) is made of a material that absorbs IR radiation and is transparent to the UV radiation.

### TECHNICAL FIELD

The invention relates to an apparatus for curing the coating of a workpiece with free radicals generated by means of ultraviolet (UV) radiation.

### PRIOR ART

Curing by ultraviolet (LTV) radiation is a widely used technique for drying or curing certain types of liquid coatings, which turns them into solid dry compounds almost immediately. This type of curing is used in various industrial and even domestic applications, e.g. to produce immediate curing of dyes, varnishes, adhesives and paint. This curing technique is based on projecting UV radiation on a workpiece or substrate provided with a coating or finish; said coating is in the form of a liquid composition that comprises a mixture of oligomers (polymers with a low molecular weight), monomers, additives and pigments, as well as compounds known as photoinitiators, which absorb UV radiation and generate free radicals. When the UV radiation reaches the coating, the photoinitiators cause the aforementioned generation of free radicals, which also cause the cross-linking (formation of a type of three-dimensional network) of the oligomers contained in the composition of the coating, with the subsequent formation a dry final coating layer.

It is known that performing UV-radiation curing in an atmospheric environment containing air is not satisfactory, due to the fact that oxygen in the air inhibits the reactivity of the composition of the coating. There are known proposals to address this problem, such as the one presented in EP1235652, in which curing is carried out by the radiation of sunlight or UV lamps in an environment or atmosphere mainly consisting of a heavy gas (preferably CO₂), with a low oxygen content. As a result, the presence of oxygen and its negative influence on the curing is reduced. A later document US20080003372 is also known, in which a method and apparatus for free-radical UV-radiation curing is described, with the particularity that the curing is implemented by immersing the substrate provided with the coating in a tank containing an inert gas atmosphere (preferably CO₂). Immersion takes place at a depth where the concentration of oxygen is sufficiently low and constant. Once the substrate is immersed, UV radiation is applied on the substrate to cure its coating. Once the coating is dry, the substrate is extracted from the inert gas atmosphere. UV radiation is applied from UV radiation sources situated on the exterior of the tank, the UV radiation passing through a window located on the wall of the tank.

A problem common to the various known apparatus, including the one described in US20080003372, is that UV-radiation emitting lamps give off heat in the form of infrared (IR) radiation, which is transmitted to the inert gas atmosphere and causes instability in the system. In the case of US20080003372, in which a two-dimensional, horizontally disposed substrate or workpiece is cured, this problem is not particularly severe as the gas level must only be kept constant up to a relatively low height (mark 1.4.2), there being enough distance over the gas level (up to mark 1.4.1) in order to disperse the turbulence in the gas. However, apparatus designed to cure three-dimensional workpieces, or workpieces of a certain height, would have to be excessively high in order to function in the same way as the apparatus in US20080003372, i.e. to disperse the turbulences in the gas situated on top of the workpiece. Obviously, such apparatus are not feasible. As a result, in apparatus for curing three-dimensional workpieces, which cannot be excessively large, the instability in the inert gas atmosphere would result in gas leaking from the apparatus, meaning that more inert gas would have to be injected into the apparatus to maintain stability. Consequently, the apparatus would consume an excessive amount of gas.

A possible solution to the problem of preventing turbulence caused by IR radiation inside a curing apparatus is to place the UV radiation sources at a certain distance from the apparatus. However, this solution is not deemed useful from a technical standpoint as it may result in the unit formed by the apparatus and the UV radiation sources being excessively large. In addition, this solution would require more powerful UV-radiation sources, impacting negatively on the power consumption of the apparatus.

The objective of the invention is to provide an apparatus for curing coatings that are formed by compositions that may be cured by means of free radicals generated by UV radiation, where UV radiation lamps can be positioned external to the tank and very close to it, and where, however, the heating of the interior of the tank is prevented, a stable system with a reasonable consumption of inert gas being obtained.

### BRIEF DESCRIPTION OF THE INVENTION

It is an object of the invention to provide an apparatus for curing the coating of a workpiece, where said coating is formed by a free-radical UV-radiation curable composition, the radiation being generated by at least one UV-radiation source. As in other known apparatus, the apparatus comprises at least one tank that contains inert gas heavier than air (preferably CO₂), with a very low oxygen content. The workpiece is introduced into the interior of said tank in order for it to be cured in said inert gas atmosphere. The UV radiation source is situated on the exterior of the tank and facing at least one window comprised in the tank. The UV radiation generated by the UV radiation source thus passes through the window towards the interior of the tank. Particularly, the apparatus of the invention comprises at least one transparent filter disposed outside the tank, between the UV radiation source and the window, where said transparent filter is made from a material that absorbs infrared (IR) radiation and is transparent to the UV radiation. The IR radiation emitted by the UV radiation source is absorbed by the transparent filter or filters (without significantly reducing the intensity of the UV radiation that reaches the interior of the tank), and as a result of which the inert gas inside the tank does not overheat. Consequently the interior of the tank is stabilised, preventing currents in the inert gas. This thus reduces the need to supply inert gas to the system, thereby reducing its inert gas consumption.

Preferably, the transparent filter is made of melted quartz crystal, which is a material that allows virtually all the UV radiation to pass through and absorbs part of the IR radiation. However, other materials may also be used, such as transparent glass, which also absorbs part of the IR radiation (although it also absorbs part of the UV radiation, as a result of which more powerful UV-radiation sources are required).

### BRIEF DESCRIPTION OF THE DRAWINGS

Details of the invention can be seen in the accompanying non-limiting drawings:

FIG. 1 shows a schematic, cross-sectional side view of the area of an embodiment of the invention in which the inventive window is shown.

FIG. 2 shows an schematic top view of the area of the apparatus of FIG. 1.

### DETAILED DESCRIPTION OF THE INVENTION

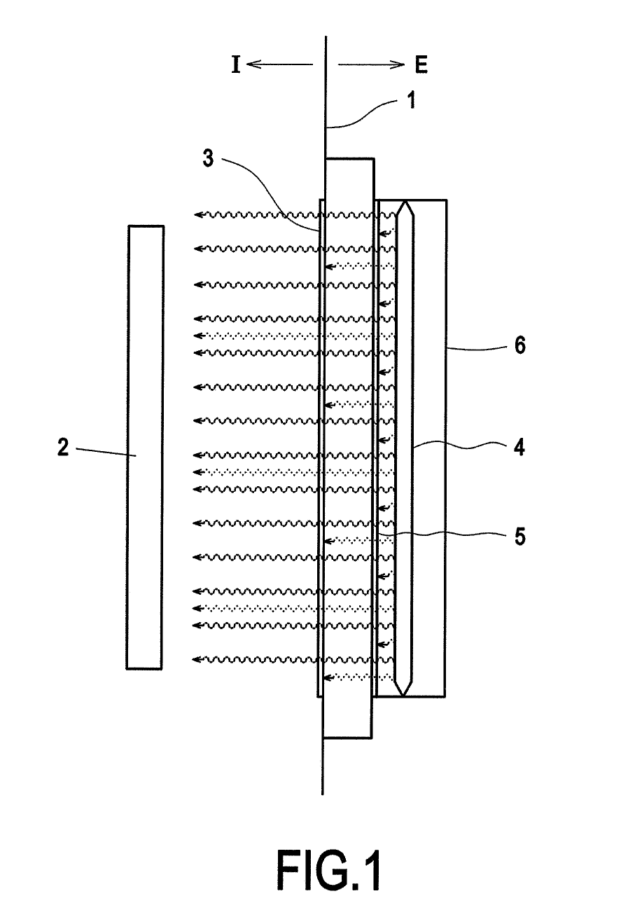

FIG. 1 shows a very schematic cross-sectional side view of an embodiment of the inventive apparatus. It specifically shows the area of said apparatus in which an ultraviolet (UV) radiation source is located. The apparatus thus comprises a tank (1), the interior (I) and exterior (E) of which are represented by arrows. An inert gas atmosphere heavier than air, preferably of CO₂, is disposed in the interior (I) of the tank (1). A workpiece (2) provided with a coating that may be cured by means of free radicals generated by UV radiation is inserted into the interior (I) of the tank (1). The apparatus comprises at least one window (3) formed in the wall of the tank (1). At least one UV-radiation source (4) is situated on the exterior (E) of the tank (1), facing the window (3). The apparatus also comprises at least one transparent filter (5) located between the UV-radiation source (4) and the window (3), where said transparent filter (5) is made of a material that absorbs IR radiation and is transparent to the UV radiation. As a result, the UV radiation (illustrated by a broken line) emitted by the UV-radiation source (4) passes through the window (3) towards the interior (I) of the tank (1). However, part of the IR radiation (illustrated by a dotted line) emitted by the UV-radiation source (4) is absorbed by the transparent filter (5), and does not reach the interior (I) of the tank (1).

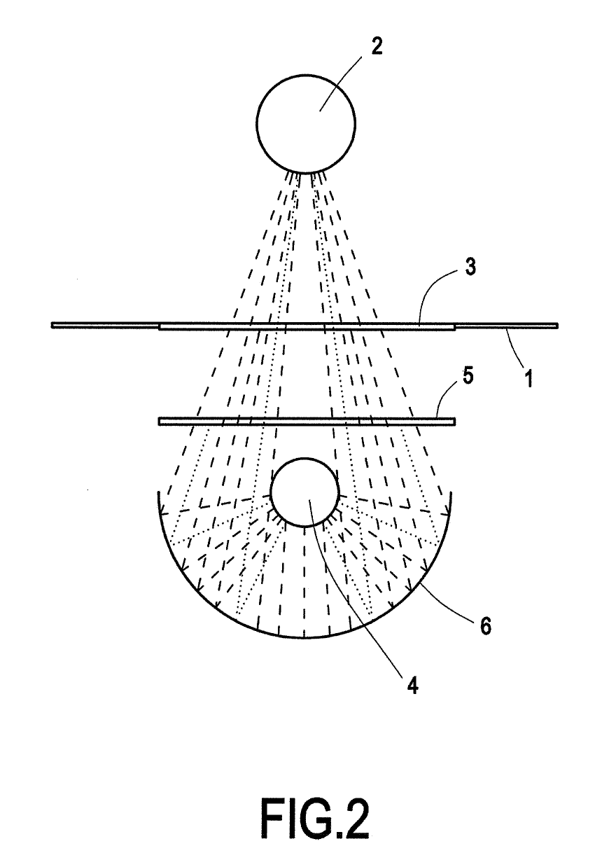

FIG. 2 shows a top view of the area of the tank (1) shown in FIG. 1.

In the embodiment shown, the apparatus comprises one transparent filter (5) located between the UV-radiation source (4) and the window (3). However, other embodiments with two or more transparent filters (5), should this be deemed suitable, are envisaged. Each transparent filter (5) helps increase the absorption of IR radiation and reduces the overheating of the interior (I) of the tank (1) to a greater extent.

Preferably, the transparent filter (5) is made of quartz crystal, although the use of other materials such as transparent glass is also envisaged.

The inventive apparatus may also comprise means for causing the circulation of relatively cold air in the outer area (E) of the tank (1), close to the window (3), in order to increase heat dissipation. Thus, in the event that it is disposed with a single transparent filter (5), as shown in the figures, the apparatus may comprise means for causing the circulation of relatively cold air in the space between the UV-radiation source (4) and the transparent filter (5), and/or in the existing space between the window (3) and the transparent filter (5). In the event that it is disposed with more than one transparent filter (5), the apparatus may comprise means for causing the circulation of relatively cold air in the existing space between the UV-radiation source (4) and the transparent filter (5) closest to the UV-radiation source (4), in the existing space between transparent filters (5), and/or in the existing space between the window (3) and the transparent filter (5) closest to the window (3), in order to increase heat dissipation. It must be remembered that it is in the area of the window (3) and the transparent filters (5) where the temperature increases most due to the absorption of IR radiation.

The apparatus may comprise at least one reflector member (6) which reflects the UV radiation emitted by the UV-radiation source (4) that is not directed towards the window (3), in order that said UV radiation is directed towards the window (3). This aspect is shown more clearly in FIG. 2, where it can be seen that the radiation that reaches the reflector member (6) is redirected towards the window (3). This provides a better performance of the apparatus, as a better use is made of the UV radiation emitted by the UV-radiation source (4).

1. Apparatus for curing the coating of a workpiece (2), where said coating is made of a composition that may be cured by means of free radicals generated by ultraviolet (UV) radiation, where the apparatus comprises at least one tank (1) that contains inert gas heavier than air and into which the workpiece (2) is introduced, and at least one UV-radiation source (4) located on the exterior (E) of the tank (1) and facing at least one window (3) comprised in the tank (1) to allow the UV radiation generated by the UV-radiation source (4) to pass through the window (3) towards the interior (I) of the tank (1), characterised in that it comprises:
at least one transparent filter (5) disposed between the UV-radiation source (4) and the window (3), where said transparent filter (5) is made of a material that absorbs IR radiation and is transparent to the UV radiation.

2. Apparatus according to claim 1, characterised in that the transparent filter (5) is made of quartz crystal.

3. Apparatus according to claim 1, characterised in that the transparent filter (5) is made of transparent glass.

4. Apparatus according to claim 1, characterised in that it comprises a single transparent filter (5) and means for causing the circulation of relatively cold air between the UV-radiation source (4) and the transparent filter (5), and/or between the window (3) and the transparent filter (5).

5. Apparatus according to claim 1, characterised in that it comprises at least two transparent filters (5) and means for causing the circulation of relatively cold air between the UV-radiation source (4) and the transparent filter (5) closest to the UV-radiation source (4), between transparent filters (5), and/or between the window (3) and the transparent filter (5) closest to the window (3).

6. Apparatus according to claim 1, characterised in that it comprises at least one reflector member (6) that reflects the UV radiation emitted by the UV-radiation source (4) that is not directed towards the window (3), in order that said UV radiation is directed towards the window (3).

7. Apparatus according to claim 1, characterised in that the inert gas is CO₂.
